(19) United States
(12) Patent Application Publication
(10) Pub. No.: US 2004/0110501 A1
(43) Pub. Date: Jun. 10, 2004

(54) Wireless network managing method and wireless network system

(75) Inventors: Isamu Arakaki, Kawasaki-shi (JP); Yoshikazu Kobayashi, Kawasaki-shi (JP)

Correspondence Address: YOUNG & THOMPSON, 745 SOUTH 23RD STREET 2ND FLOOR, ARLINGTON, VA, 22202

(73) Assignee: NEC INFRONTIA CORPORATION, KAWASAKI-SHI (JP)

(21) Appl. No.: 10/669,560

(22) Filed: Sep. 25, 2003

(30) Foreign Application Priority Data
Dec. 2, 2002 (JP) 2002-349379

(51) Int. Cl. H04Q 7/20

(52) U.S. Cl. 455/426.2; 455/434; 455/450

(57) ABSTRACT

When a user is confirmed to be a subscriber of a mobile communication network, to which a manager of hot spots is tied up with its dealer, at the time of accessing of an access point in the location of one of these hot spots by the user, the user can utilize communication services as one who has met the confirmation at these hot spots.

### BACKGROUND OF THE INVENTION

This application claims benefit of Japanese Patent Application No. 2002-349379 filed on Dec. 2, 2002 contents of which are incorporated by the reference.

The invention relates to a wireless network managing method and a wireless network system, which manage communication services including internet connection and so forth to permit access to a predetermined access point in a certain limited geographical location via a wireless LAN or like local wireless interface such as a hot spot.

So-called “hot spot service”, i.e., management of internet connection and contents services, provided in limited places such as airports, hotels, coffee shops and such shops as first food shops, are now becoming to be put to practical use. This service manages internet connection and like services provided in very limited areas with wireless techniques called local wireless interface such as wireless LAN or Bluetooth.

In such hot spot, for utilizing communication services with wireless LAN or like local wireless service, registration and authentication for the approval of utilizing the communication services in that hot spot are usually necessary.

Techniques concerning authentication by a wireless LAN system concerning a mobile station found in the geographical location of the hot spot has heretofore been proposed. See Literature 1 (Japanese patent laid-open No. 2001-345819) and Literature 2 (Japanese patent national publication No. 2001-507540), for instance.

However, no particular attention is paid to the cumbersomeness that the user has to make authentication for the approval of communication service utilization even in the case of the techniques disclosed in either of the above prior art literatures. Heretofore, as shown in FIG. 2, the user 10 can usually utilize communication services after receiving user registration and authentication for each of hot spots 21 to 24, for which the user desired receiving the communication services, and pays fees charged according to the extent of results of utilization. For the user, however, it is extremely complicated that no communication service can be utilized unless the user waits for the operation of receiving the user registration and authentication for each of the plurality of hot spots 21 to 24.

### SUMMARY OF THE INVENTION

An object of the invention is to provide a wireless network managing method and a wireless network system, which preclude the cumbersomeness that it is necessary, even in the case of utilizing wireless communication services of a plurality of hot spots, to wait for the authentication for each hot spot.

According to an aspect of the present invention, there is provided a wireless network managing method, wherein in a hot spot permitting access to a predetermined access point in a limited location via a local wireless interface such as wireless LAN, a communication service utilizing a mobile communication network managed by a communication dealer tied up with the own manager is provided, and in the location of the hot spot a user who is confirmed, according to the telephone number or the like of a mobile station, to be a subscriber of a mobile communication network managed by the communication dealer, is approved as one who has met necessary authentication to utilize communication service in the hot spot.

The confirmation that the user is a subscriber of a mobile communication network managed by the communication dealer is made when the user accesses the access point. When the confirmation that the user is a subscriber of the mobile communication network managed by the communication dealer, the user is approved as one who has met necessary authentication to utilize communication services in the hot spot with respect to a plurality of hot spots providing communication services utilizing a mobile communication network managed by the communication dealer. The hot spot manager pays a communication fee corresponding to the extent of user of communication service by users in each hot spot, and the communication user demands communication expenditures to each user. The mobile communication network managed by the communication dealer is a mobile communication network by PHS. The communication dealer provides by prepaid or rental provision of a means for limiting the extent of number of times, time interval, etc. approval of communication with wireless LAN card or the like to pertinent persons among the mobile communication network subscribers.

According to another aspect of the present invention, there is provided a wireless network system, wherein in the hot spot permitting access to a predetermined access point in a limited location, and providing communication services utilizing a mobile communication network managed by a communication dealer tied up with the own manager, and in the location of the hot spot a user who is confirmed, according to the telephone number of a mobile station or the like, that he or she is a subscriber of the mobile communication network managed by the communication dealer is approved as one having met necessary authentication to utilize the communication services in the hot spot.

The confirmation that the user is a subscriber of the mobile communication network managed by the communication dealer, is executed when the user accesses the access point.

Other objects and features will be clarified from the following description with reference to attached drawings.

### BRIEF DESCRIPTION OF THE DRAWINGS

FIG. 1 is a block diagram for describing a wireless network management method and a wireless network system according to the invention; and

FIG. 2 is a schematic diagram for describing a prior art wireless communication service.

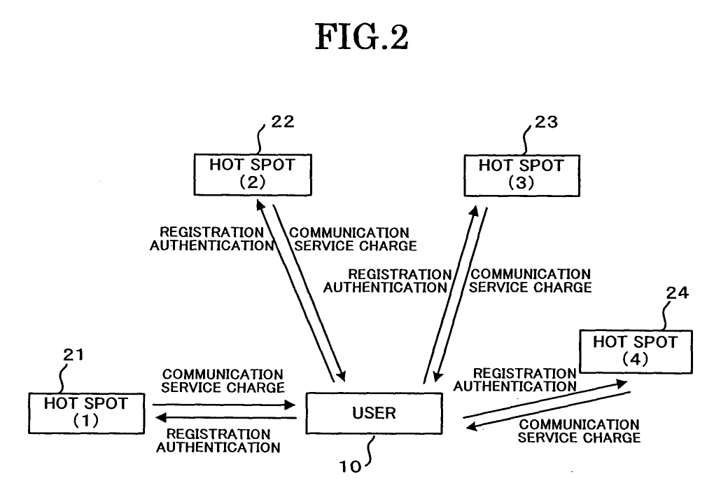

### PREFERRED EMBODIMENTS OF THE INVENTION

Preferred embodiments of the present invention will now be described with reference to the drawings.

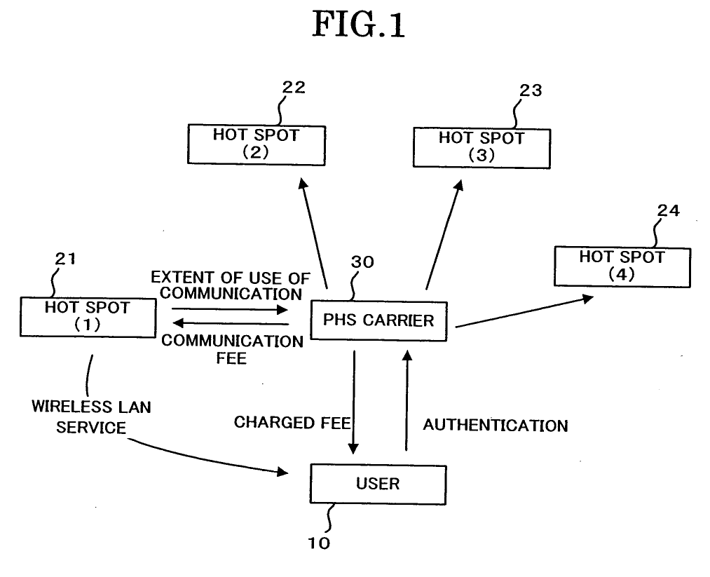

FIG. 1 is a block diagram for describing a wireless network management method and a wireless network system according to the invention.

In the wireless network system for carrying out the wireless network management method according to the invention, as for the reception of communication services by the user 10 in a plurality of hot spots 21 to 24, a user who is confirmed on the basis of the telephone number or the like of a mobile station (i.e., PHS, for instance) that he or she is a subscriber of a communication dealer having concluded a tie-up relation with the manager of each hot spot, for instance a PHS carrier 30, is approved to be one who has met a necessary authentication for utilizing communication services in any one of the above hot spots 21 to 24.

The term “carrier” usually means a first class communication dealer having communication facility in the own company. From the standpoint of the subject matter of the invention, however, this is by no means limitative. Thus, in this specification, this term is used such that it covers all electric communication dealers.

In the above example, the confirmation in the location of each of the hot spots 21 to 24 that the user 10 is a subscriber of a mobile communication network managed by the PHS carrier 30 as communication dealer 10 is executed when the user 10 accesses the pertinent access point of that hot spot.

When it is confirmed that the user 10 is a subscriber of the mobile communication network managed by the above communication dealer (i.e., PHS carrier 30), regarding the plurality of hot spots 21 to 24 which provide communication services utilizing the mobile communication network managed by the above communication dealer, the pertinent user 10 is approved as one having met necessary authentication to utilize communication services in these hot spots.

By this authentication, the user 10 is released from the cumbersomeness that he or she has to carry out the procedure of independent authentication for each of the hot spots 21 to 24, and when he or she arrives at any of the hot spots 21 to 24 by his or her own movement, at that point he or she can immediately utilize communication services in the pertinent hot spot.

On the other hand, the manager of the hot spots 21 to 24 pays the communication fee corresponding to the extent of use of communication services by the users in the location of each hot spot in response to a demand by the communication dealer (i.e., the PHS carrier 30 in this embodiment), and the communication dealer demands the communication expenditures to each user.

As an alternative method dealing with the communication fees or the like, the communication dealer (i.e., PHS carrier 30) may manage the system by prepaid or rental provision of a means for limiting such quantity as the number of times or time interval of approval of the communication by the wireless LAN card or the like to pertinent mobile communication network subscribers, for instance particularly desiring particular subscribers, or in some cases all the subscribers. By this method, such labor as demanding individual fees or making corresponding payments can be reduced.

While the above description has been made in connection with a case, in which the communication dealer is a PHS carrier, that is, the mobile station of the mobile communication network is PHS, the concept underlying the present invention is not limited to this case; for example, the invention is of course applicable to the case of communication network based on the ordinary portable telephone system.

As has been described in the foregoing, according to the invention the user is released from the cumbersomeness that it is necessary to carry out the procedure of authentication afresh for every one of hot spots, which are managed by a manager tied up with a mobile communication network dealer, to which the user itself has been subscribed, and thus the convenience can be improved.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

What is claimed is:

1. A wireless network managing method, wherein in a hot spot permitting access to a predetermined access point in a limited location via a local wireless interface such as wireless LAN, a communication service utilizing a mobile communication network managed by a communication dealer tied up with the own manager is provided, and in the location of the hot spot a user who is confirmed, according to the telephone number or the like of a mobile station, to be a subscriber of a mobile communication network managed by the communication dealer, is approved as one who has met necessary authentication to utilize communication service in the hot spot.

2. The wireless network managing method according to claim 1, wherein the confirmation that the user is a subscriber of a mobile communication network managed by the communication dealer is made when the user accesses the access point.

3. The wireless network managing method according to claim 1, wherein when the confirmation that the user is a subscriber of the mobile communication network managed by the communication dealer, the user is approved as one who has met necessary authentication to utilize communication services in the hot spot with respect to a plurality of hot spots providing communication services utilizing a mobile communication network managed by the communication dealer.

4. The wireless network managing method according to claim 1, wherein the hot spot manager pays a communication fee corresponding to the extent of user of communication service by users in each hot spot, and the communication user demands communication expenditures to each user.

5. The wireless network managing method according to claim 1, wherein the mobile communication network managed by the communication dealer is a mobile communication network by PHS.

6. The wireless network managing method according to claim 1, wherein the communication dealer provides by prepaid or rental provision of a means for limiting the extent of number of times, time interval, etc. approval of communication with wireless LAN card or the like to pertinent persons among the mobile communication network subscribers.

7. A wireless network system, wherein in the hot spot permitting access to a predetermined access point in a limited location, and providing communication services utilizing a mobile communication network managed by a communication dealer tied up with the own manager, and in the location of the hot spot a user who is confirmed, according to the telephone number of a mobile station or the like, that he or she is a subscriber of the mobile communication network managed by the communication dealer is approved as one having met necessary authentication to utilize the communication services in the hot spot.

8. The wireless network system according to claim 7, wherein the confirmation that the user is a subscriber of the mobile communication network managed by the communication dealer, is executed when the user accesses the access point.
